(19) United States
(12) Patent Application Publication
(10) Pub. No.: US 2015/0116605 A1
(43) Pub. Date: Apr. 30, 2015

(54) DISPLAY PANEL

(71) Applicant: Chunghwa Picture Tubes, LTD., Taoyuan (TW)

(72) Inventors: Jiun-Jr Huang, Yilan County (TW); Hsu-Ping Chiu, Taoyuan County (TW); Jen-Kuang Yang, Hsinchu County (TW)

(73) Assignee: Chunghwa Picture Tubes, LTD., Taoyuan (TW)

(21) Appl. No.: 14/098,531

(22) Filed: Dec. 6, 2013

(30) Foreign Application Priority Data
Oct. 24, 2013 (TW) 102138526

(51) Int. Cl. G02F 1/1343; G02F 1/1333; G02F 1/1335

(52) U.S. Cl. CPC G02F 1/134309; G02F 1/133512; G02F 1/13338; G02F 1/133514; G02F 2001/134372
USPC 349/12; 349/106

(57) ABSTRACT

A display panel having a display region and a non-display region is provided, which includes a pixel array substrate, a color filter substrate, at least one conductive structure and a display medium. The color filter substrate includes a first substrate, a black matrix layer, a color filter layer and an electrostatic protection layer. The black matrix layer defines first openings in the display region. The color filter layer includes color filter patterns located in the first openings. The electrostatic protection layer is located at least between the black matrix layer and a portion of the color filter layer. The conductive structure is located between the pixel array substrate and the color filter substrate and in the non-display region, wherein the electrostatic protection layer is further disposed between the black matrix layer and the conductive structure. The electrostatic protection layer is electrically connected with the conductive structure.

### CROSS-REFERENCE TO RELATED APPLICATION

This application claims the priority benefit of Taiwan application serial no. 102138526, filed on Oct. 24, 2013. The entirety of the above-mentioned patent application is hereby incorporated by reference herein and made a part of this specification.

### FIELD OF THE INVENTION

The invention relates to a display panel, and more particularly, to a display panel with an electrostatic protection layer.

### DESCRIPTION OF RELATED ART

Nowadays, major demands for a liquid crystal display (LCD) panel in market include high contrast ratio, no gray scale inversion, high brightness, high color saturation, a rapid response, and a wide-viewing angle. Fringe field switching (FFS) LCD panel is one of the most widely used display panels, which has advantages including low power consumption, high transmittance, high brightness, a rapid response, little color shift, and high color reproductivity.

Nevertheless, in the conventional FFS LCD panel, the common electrode and the pixel electrode are disposed on the pixel array substrate. When the color filter substrate undergoes an electrostatic discharge (ESD) effect, the display panel results in an instability phenomenon, such as an unexpected functional disorder. In the worst case, the electronic components inside the electronic products will be damaged due to an unbearable static voltage or current. A way to improve the capability against the ESD effect for the display panel is by disposing an transparent indium-tin-oxide (ITO) layer on a surface of the color filter substrate away from the pixel array substrate and using silver paste to conduct static electricity. However, the color filter substrate needs to be flipped over in order to form an ITO layer by said method and a dotting process is required to perform manually in order to make the conductive silver paste, which cause more problems such as making fabrication processes more difficult and increasing fabrication cost.

### SUMMARY OF THE INVENTION

The invention provides a display panel which has improved capability against an ESD effect.

In the display panel of the invention, an electrostatic protection layer is located on a surface of a color filter substrate close to a pixel array substrate, so a conductive structure of the invention, for example, can be fabricated by an automatic dotting process and include a plurality of gold balls, for example. Hence, compared with the traditional display panel (which is manually dotting silver paste and disposing the electrostatic protection layer on a surface of the color filter substrate away from the pixel array substrate), a structure design of the display panel of the invention has advantages, such as using an automatic dotting process and no need to flip over the color filter substrate for fabricating the electrostatic protection layer. Here, the invention can reduce a dotting tolerance and fabricate a conductive structure and a pad with smaller sizes according to the automatic dotting process, thereby reducing the layout space of the circuit in a non-display region. Besides, since the fabricating step of flipping over the substrate is not needed, the fabrication process can be simplified to save cost and workforce and further reduce possibilities of scratching and fragmentation. Additionally, since the transparent indium-tin-oxide (ITO) layer is not disposed on the surface of the color filter substrate away from the pixel array substrate, after configuring the color filter substrate and the pixel array substrate, a second fabricating process can be performed to make the display panel thinner.

The invention provides a display panel having a display region and a non-display region. The display panel includes a pixel array substrate, a color filter substrate, at least one conductive structure, and a display medium. The color filter substrate is disposed opposite to the pixel array substrate. The color filter substrate includes a first substrate, a black matrix layer, a color filter layer, and an electrostatic protection layer. The black matrix layer is located on the first substrate to define a plurality of first openings in the display region, and the black matrix layer further extends from the display region to the non-display region. The color filter layer includes a plurality of color filter patterns, which the color filter patterns are located in the corresponding first openings, respectively. The electrostatic protection layer is located at least between the black matrix layer and a portion of the color filter layer. The at least one conductive structure is located between the pixel array substrate and the color filter substrate and in the non-display region. The electrostatic protection layer is further located between the black matrix layer and the at least one conductive structure, and the electrostatic protection layer is electrically connected to the at least one conductive structure. The display medium is located between the pixel array substrate and the color filter substrate.

Based on the above, in the display panel of the invention, the electrostatic charges in the color filter substrate is dispersed via a charge guiding path so as to inhibit an electrostatic charge accumulation, thereby enhancing the capability against the ESD effect for the display panel. The charge guiding path is formed by a configuration of the electrostatic protection layer of the color filter substrate and the conductive structure. Besides, electrodes of the electrostatic protection layer in the invention are electrically connected to corresponding transmission lines via the corresponding conductive structure, respectively. Since the transmission lines are electrically connected to a common voltage source or a sensing voltage source, the electrostatic protection layer of the display panel and the design structure of the electrodes thereof have advantages such as high aperture ratio, enhanced capability against the ESD effect, touch control function, and so on.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic top view of a display panel according to a first embodiment of the invention.

FIG. 2 is a schematic cross-sectional view of the display panel of FIG. 1 along a line I-I′.

FIG. 3 is a schematic top view of a display panel according to a second embodiment of the invention.

FIG. 4 is a schematic cross-sectional view of the display panel of FIG. 3 along a line I-I′.

FIG. 5A is a schematic top view of an electrostatic protection layer according to other embodiment of the invention.

FIG. 5B is a schematic top view of an electrostatic protection layer according to other embodiment of the invention.

FIG. 6 is a schematic top view of a display panel according to a third embodiment of the invention.

FIG. 7A is a schematic partial top view of a first electrode and a second electrode of FIG. 6.

FIG. 7B is a schematic partial top view of a first electrode and a second electrode according to other embodiment of the invention.

FIG. 7C is a schematic partial top view of a first electrode and a second electrode according to other embodiment of the invention.

### DESCRIPTION OF THE EMBODIMENTS

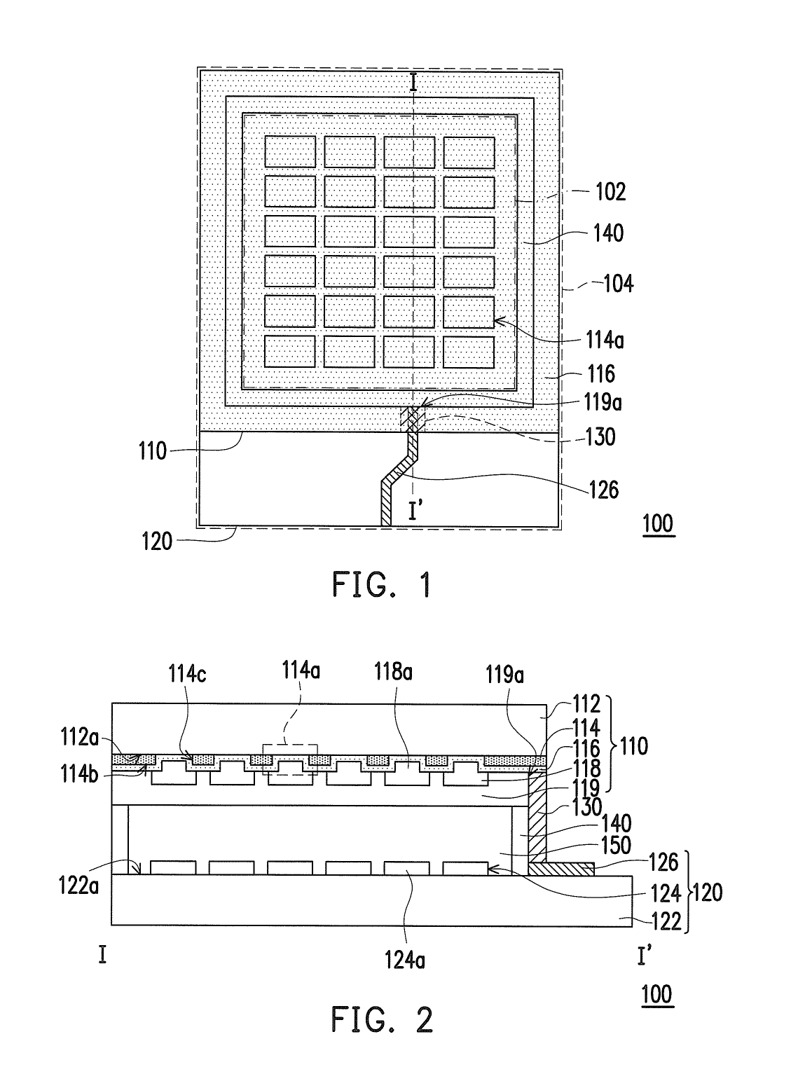

FIG. 1 is a schematic top view of a display panel according to a first embodiment of the invention. FIG. 2 is a schematic cross-sectional view of the display panel of FIG. 1 along line I-I′.

Referring to FIG. 1 and FIG. 2, a display panel 100 includes a display region 102 and a non-display region 104 surrounding the display region 102. The display panel 100 is a FFS LCD panel, for example. In the following embodiments of the invention, the display panel 100 is a FFS LCD panel for illustration purposes. The display panel 100 includes a color filter substrate 110, a pixel array substrate 120 opposite to the color filter substrate 110, a conductive structure 130, a sealant 140, and a display medium 150.

The color filter substrate 110 includes a first substrate 112, a black matrix layer 114, an electrostatic protection layer 116, a color filter layer 118, and a planarization layer 119.

A material of the first substrate 112 includes glass, quartz, organic polymers, or other suitable materials. The first substrate 112 includes a first surface 112a facing the pixel array substrate 120.

The black matrix layer 114 is located on the first surface 112a of the first substrate 112, and the black matrix layer 114 further extends from the display region 102 to the non-display region 104. The black matrix layer 114 defines a plurality of first openings 114a in the display region 102, in which the first openings 114a exposes a portion of the first surface 112a of the first substrate 112. Namely, the black matrix layer 114 is located on the display region 102 and the non-display region 104, wherein the black matrix layer 114 located in the display region 102 has the first openings 114a arranged in form of matrix. A material of the black matrix layer 114 includes a black resin, an organic light-shielding material, or other suitable materials, for example. Furthermore, the black matrix layer 114 includes a second surface 114b and a side wall 114c. The second surface 114b is facing the pixel array substrate 120.

The electrostatic protection layer 116 covers the entire second surface 114b and the side wall 114c of the black matrix layer 114 and fills into the first openings 114a. Accordingly, the electrostatic protection layer 116 conformally and completely covers the second surface 114b and the side wall 114c of the black matrix layer 114 and the first surface 112a exposed by the first openings 114a. In other words, the electrostatic protection layer 116 is located on the display region 102 and the non-display region 104. In the present embodiment, a material of the electrostatic protection layer 116, for example, includes a transparent conductive material, so an influence of the electrostatic protection layer 116 on the display image of the display panel 110 is reduced, thereby maintaining a certain optical quality of the display panel 100. The transparent conductive material includes indium tin oxide (ITO) or other suitable conductive materials of high electric conductivity.

The color filter layer 118 is disposed on the electrostatic protection layer 116 and includes a plurality of color filter patterns 118a. Each of the color filter patterns 118a is respectively disposed in the corresponding one of the first openings 114a, and the color filter patterns 118a further extend to a portion of the second surface 114b of the black matrix layer 114. Therefore, a portion of the electrostatic protection layer 116 is located between the second surface 114b of the black matrix layer 114 and the color filter layer 118. Namely, the color filter patterns 118a located in the display region 102 are also arranged in form of matrix. For instance, the color filter patterns 118a include red filter patterns, green filter patterns, and blue filter patterns, but the invention is not limited thereto. The color filter patterns 118a may include various color combinations, shapes, or configurations. Materials of the color filter patterns 118a include colored resins or other suitable materials, for example.

The planarization layer 119 is located on the first surface 112a of the first substrate 112, which completely covers the black matrix layer 114, the electrostatic protection layer 116, and the color filter layer 118. A material of the planarization layer 119 includes silicon oxide, silicon nitride, silicon oxy-nitride or other suitable insulating materials. Moreover, the planarization layer 119 includes a opening 119a. The opening 119a is located in the non-display region 104 and exposes a portion of the electrostatic protection layer 116.

The pixel array substrate 120 includes a second substrate 122, a pixel array layer 124, and a pad 126.

A material of the second substrate 122 includes glass, quartz, organic polymers, or other suitable materials. The second substrate 122 includes a third surface 122a facing the color filter substrate 110.

The pixel array layer 124 is located on the third surface 122a of the second substrate 122 and in the display region 102. The pixel array layer 124 includes a plurality of pixels 124a arranged in form of matrix. In the embodiment, the pixels 124a, for example, are sub-pixels. Each of the pixels 124a is disposed corresponding to one of the openings 114a, respectively. For clarity, non-illustrated components included in the pixels 124a of FIG. 1 and FIG. 2, such as scan lines, data lines, active devices, and pixel electrodes, are omitted. These omitted components are known to those having ordinary skill in the art and are not repeated herein.

The pad 126 is located on the third surface 122a of the second substrate 122, and in the non-display region 104. A material of the pad 126 includes a metal material, an alloy, or other suitable conductive materials, for example.

The conductive structure 130 is located between the pixel array substrate 120 and the color filter substrate 110 and in the non-display region 104. Furthermore, the conductive structure 130 is located in the opening 119a and electrically connected to the electrostatic protection layer 116. Namely, the electrostatic protection layer 116 is further located between the black matrix layer 114 and the conductive structure 130. The conductive structure 130 may include a plurality of conductive balls (not illustrated). The conductive balls includes gold balls, metal balls, or alloy balls.

In the embodiment, the pad 126 is electrically connected to a common voltage source, and the electrostatic protection layer 116 of the color filter substrate 110 is electrically connected to the pad 126 of the pixel array substrate 120 via the conductive structure 130 to form a charge guiding path. This way, the electrostatic charges in the color filter substrate 110 is dispersed via the charge guiding path so as to inhibit an electrostatic charge accumulation, thereby enhancing the capability against the ESD effect for the display panel 100.

It is noted that, since the electrostatic protection layer 116 of the color filter substrate 110 is located on the first surface 112a facing the pixel array substrate 120, the conductive structure 130 of the invention, for example, can be fabricated by an automatic dotting process and include a plurality of gold balls, for example. Hence, compared with the traditional display panel (which is manually dotting silver paste and disposing the electrostatic protection layer on a surface of the color filter substrate away from the pixel array substrate), a structure design of the display panel 100 of the invention has advantages, such as using the automatic dotting process and no need to flip over the color filter substrate 110 for fabricating the electrostatic protection layer. Here, the invention can reduce a dotting tolerance and fabricate the conductive structure 130 and the pad 126 with smaller sizes according to the automatic dotting process, thereby reducing the layout space of the circuit in the non-display region. Besides, since the fabricating step of flipping over the substrate is not needed, the fabrication process can be simplified to save cost and workforce and further reduce possibilities of scratching and fragmentation. Additionally, since the transparent indium-tin-oxide (ITO) layer is not disposed on a second surface of the color filter substrate 110 away from the pixel array substrate 120, a secondary fabricating process can be performed to make the display panel 100 thinner after configuring the color filter substrate 110 and the pixel array substrate 120.

The sealant 140 is located between the pixel array substrate 120 and the color filter substrate 110 and surrounds the display region 102. A material of the sealant 140 includes a photo-curing material, a thermosetting material, or other suitable curing materials.

The display medium 150 is located between the pixel array substrate 120 and the color filter substrate 110 and in the display region 102. In the embodiment, the display panel 100 may be a FFS LCD panel such that the display medium 150 includes liquid crystal molecules.

As an example, in the afore-mentioned embodiment of FIG. 1 and FIG. 2, the electrostatic protection layer 116 covers the entire second surface 114b and the side wall 114c of the black matrix layer 114 and fills into the first openings 114a, but the invention is not limited thereto. In other embodiments of the invention, the electrostatic protection layer is located at least on a portion of the second surface of the black matrix layer.

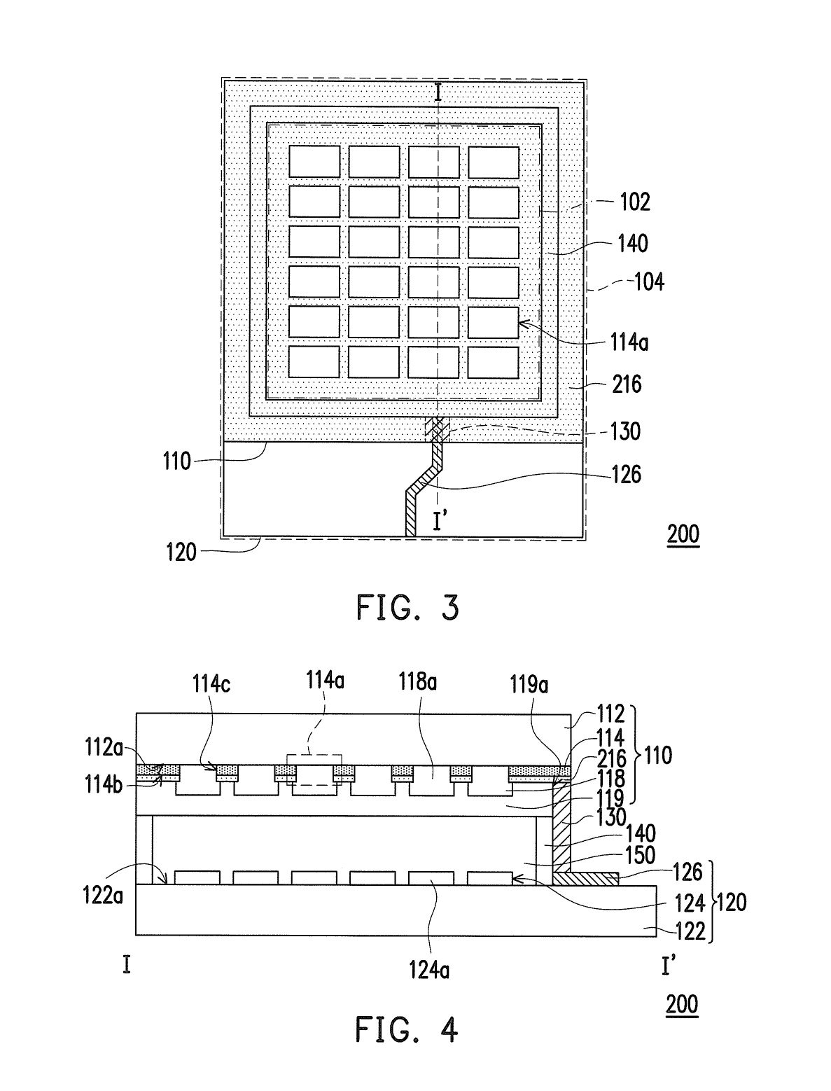

FIG. 3 is a schematic top view of a display panel according to a second embodiment of the invention. FIG. 4 is a schematic cross-sectional view of the display panel of FIG. 3 along line I-I′. The embodiment of FIG. 3 and FIG. 4 is similar to the afore-mentioned embodiment of FIG. 1 and FIG. 2, wherein identical or similar elements are denoted by identical or similar reference numerals. Description of the same elements will be omitted hereinafter, and only the differences will be explained below. Please refer to FIG. 3 and FIG. 4, the embodiment of FIG. 3 and FIG. 4 is similar to the afore-mentioned embodiment of FIG. 1 and FIG. 2, and one of the differences is that the electrostatic protection layer 216 is only located on the entire second surface 114b of the black matrix layer 114. Namely, in the display panel 200, the electrostatic protection layer 216 of the color filter substrate 110 is not located in the first openings 114a. Thus, a portion of the electrostatic protection layer 216 is at least located between the second surface 114b of the black matrix layer 114 and a portion of the color filter layer 118. Furthermore, the electrostatic protection layer 216 extends from the display region 102 to the non-display region 104 and is electrically connected to the conductive structure 130.

In the embodiment, the electrostatic protection layer 216 of the color filter substrate 110 is located on the entire second surface 114b of the black matrix layer 114 (i.e., the electrostatic protection layer 216 is not located in the first opening 114a, and the first openings 114a are corresponding to the pixels 124a). The shapes of the electrostatic protection layer 216 and the black matrix layer 114 are the same. Therefore, the patterned electrostatic protection layer 216 prevents interfering with the display medium 150 located above the pixels 124a, which also avoids issues, such as a disclination phenomenon occurring in the display panel, and low transmittance. Moreover, a material of the electrostatic protection layer 216 can further include a metal material of a better electrical conductivity, and is not limited to a transparent conductive material. In the embodiment, the material of the electrostatic protection layer 216 includes an opaque conductive material or a transparent conductive material, for example. The opaque conductive material includes a metal, an alloy, or other suitable opaque materials of high electrical conductivity. The transparent conductive material includes indium tin oxide (ITO) or other suitable conductive materials of high electrical conductivity.

As an example, in the afore-mentioned embodiment of FIG. 3 and FIG. 4, the electrostatic protection layer 216 is located on the entire second surface 114b of the black matrix layer 114, i.e. the shapes of the electrostatic protection layer 216 and the black matrix layer 114 are the same, but the invention is not limited thereto. In other embodiments of the invention, the electrostatic protection layer is located at least on a portion of the second surface of the black matrix layer, and the shapes of the electrostatic protection layer and the black matrix layer 114 are not completely the same.

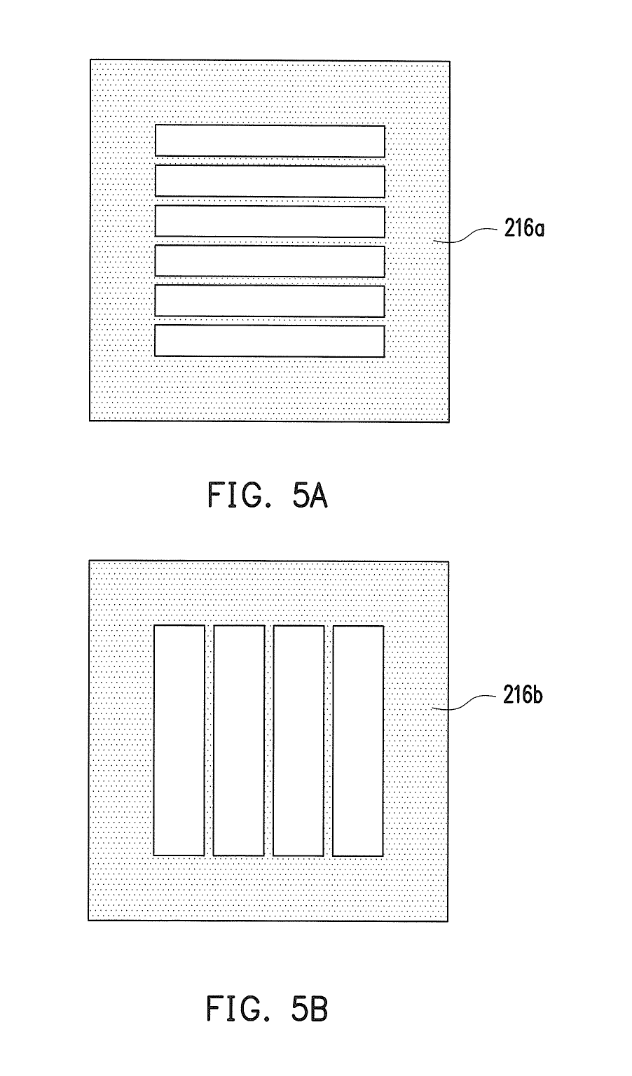

FIG. 5A and FIG. 5B is a schematic top view of an electrostatic protection layer according to other embodiment of the invention. The embodiment of FIG. 5A and FIG. 5B is approximately the same as the afore-mentioned embodiment of FIG. 3 and FIG. 4, wherein identical or similar elements are denoted by identical or similar reference numerals. Description of the same elements will be omitted hereinafter, and only the differences will be explained below. Please refer to FIG. 3-FIG. 5B, the embodiment of FIG. 5A and FIG. 5B is similar to the afore-mentioned embodiment of FIG. 3 and FIG. 4, and one of the differences is that the electrostatic protection layers 216a and 216b are located on a portion of the second surface 114b of the black matrix layer 114. Here, the electrostatic protection layer 216a is not disposed in the first openings 114a of each row, and the electrostatic protection layer 216b is not disposed in the first openings 114a of each column. Furthermore, the invention does not pose any limitation to the shapes of the electrostatic protection layers 216a and 216b. As an example, the shapes of the electrostatic protection layers 216a and 216b and the black matrix layer 114 can be similar or completely different. That is, in the embodiment, the electrostatic protection layers 216a and 216b are located on the portion of the second surface 114b of the black matrix layer 114, and the patterned electrostatic protection layers 216a and 216b further extend from the display region 102 to the non-display region 104 to electrically connect to the conductive structure 130 and the pad 126, and then form the charge guiding path.

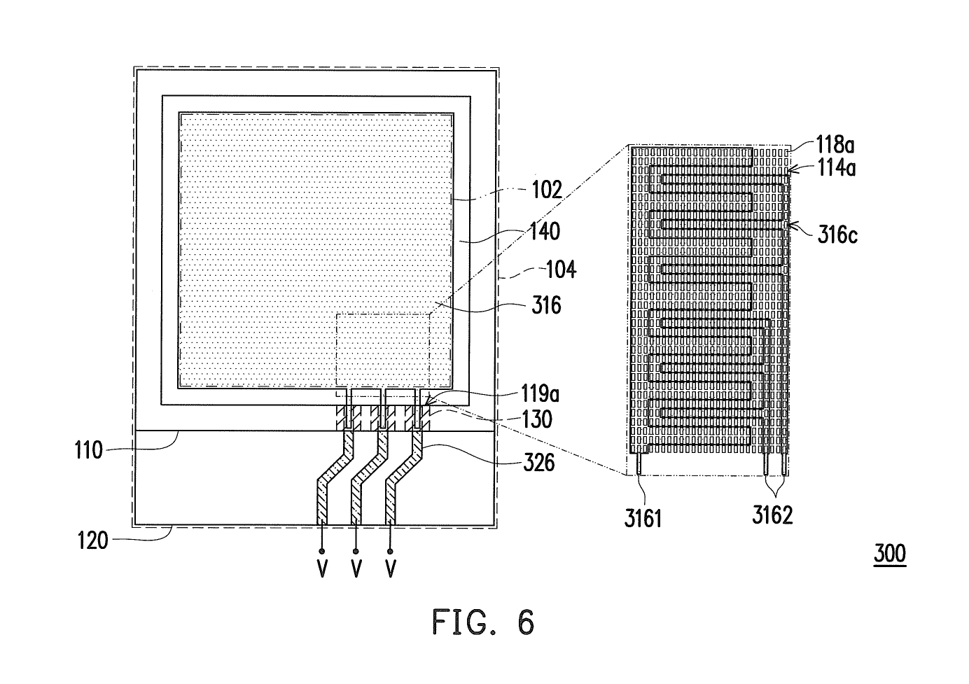

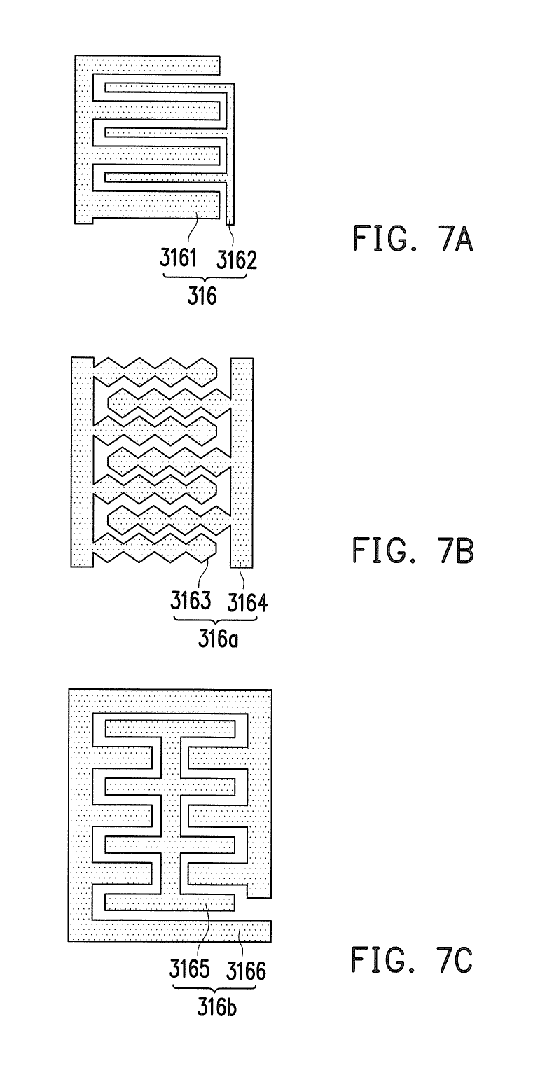

FIG. 6 is a schematic top view of a display panel according to a third embodiment of the invention. FIG. 7A is a schematic partial top view of a first electrode and a second electrode of FIG. 6. FIGS. 7B and 7C is schematic partial top views of a first electrode and a second electrode according to other embodiments of the invention.

The embodiment of FIG. 6 and FIG. 7A is similar to the afore-mentioned embodiment of FIG. 3 and FIG. 4, wherein identical or similar elements are denoted by identical or similar reference numerals. Description of the same elements will be omitted hereinafter, and only the differences will be explained below. Please refer to FIG. 6 and FIG. 7A, the embodiment of FIG. 6 and FIG. 7A is similar to the afore-mentioned embodiment of FIG. 3 and FIG. 4, and one of the differences is that the electrostatic protection layer 316 includes at least one first electrode 3161 and at least one second electrode 3162, and the display panel 300 includes at least one conductive structure 130 and a plurality of transmission lines 326.

The electrostatic protection layer 316 of the color filter substrate 110 is located in the display region 102, and the at least one first electrode 3161 and the at least one second electrode 3162 of the electrostatic protection layer 316 are electrically insulated from each other. In the embodiment, the first electrode 3161 and the second electrode 3162 have mesh-patterns. The mesh-patterns include a plurality of second openings 316c, and the second openings 316c correspondingly expose the first openings 114a. Thus, materials of the first electrode 3161 and the second electrode 3162 can be metal materials of a better conductivity, but are not limited to transparent conductive materials. However, the invention is not limited thereto. In other embodiments, the first electrode 3161 and the second electrode 3162 include a plurality of second openings 316c exposing none of the first openings 114a or a portion of the first openings 114a. Here, the materials of the first electrode 3161 and the second electrode 3162, for example, include transparent conductive materials so as to avoid interfering with the optical quality of the display panel 300.

Further, in the embodiment, the color filter substrate 110 includes at least one conductive structure 130, i.e. the color filter substrate 110 includes a plurality of the conductive structures 130. The first electrode 3161 and the second electrode 3162 are electrically connected to the corresponding conductive structures 130, respectively.

The pixel array substrate 120 includes a plurality of the transmission lines 326. The transmission lines 326 are located on the third surface 122a of the second substrate 122 and in the non-display region 104. A material of the transmission lines 326 includes a metal, an alloy, or other suitable conductive materials, for example.

It is noted that, in the embodiment, the first electrode 3161 is electrically connected to the corresponding transmission lines 326 via the corresponding conductive structures 130. The second electrode 3162 is electrically connected to the corresponding transmission lines 326 via the corresponding conductive structures 130. The first electrode 3161 and the second electrode 3162 can be touch electrodes, for example. Furthermore, in the embodiment, the transmission lines 326 are electrically connected to a voltage source V, which is electrically connected to a common voltage source or electrically connected to a sensing voltage source. When the transmission lines 326 are electrically connected to the common voltage source, the charge guiding path is formed. When the transmission lines 326 are electrically connected to the sensing voltage source, a touch operation is performed on the display panel 300 to produce a capacitive touch signal. That is, in the embodiment, the electrostatic protection layer 316 of the display panel 300 and the design structure of the electrodes thereof have advantages such as high aperture ratio, enhanced capability against the ESD effect, touch function, and so on.

Further, in the embodiment, the shapes of the first electrode 3161 and the second electrode 3162 of the electrostatic protection layer 316 respectively include comb-like shapes having a plurality of long strips, which are alternately arranged with each other, but the invention does not pose any limitation thereto. In other embodiments, the electrostatic protection layer having the first electrode and the second electrode may have other shapes or configurations. As an example, as shown in FIG. 7B, the shapes of the first electrode 3163 and the second electrode 3164 of the electrostatic protection layer 316a respectively include comb-like shapes having a plurality of rhombic shapes in series, which are alternately arranged with each other. Alternatively, as shown in FIG. 7C, the shape of the first electrode 3165 of the electrostatic protection layer 316b includes a double-sided, comb-like shape having a plurality of long strips. The shape of the second electrode 3166 of the electrostatic protection layer 316b includes a rectangular shape having a plurality of long strips. This way, the second electrode 3166 in the rectangular shape surrounds the first electrode 3165, and the long strips of the two electrodes are alternately arranged with each other.

What is claimed is:

1. A display panel having a display region and a non-display region, the display panel comprising:
a pixel array substrate;
a color filter substrate disposed opposite to the pixel array substrate, the color filter substrate comprising:
a first substrate;
a black matrix layer located on the first substrate to define a plurality of first openings in the display region, wherein the black matrix layer further extends from the display region to the non-display region;
a color filter layer having a plurality of color filter patterns, wherein the color filter patterns are respectively located in the corresponding first openings;
an electrostatic protection layer located at least between the black matrix layer and a portion of the color filter layer;
at least one conductive structure located between the pixel array substrate and the color filter substrate, and in the non-display region, wherein the electrostatic protection layer is further located between the black matrix layer and the conductive structure, and the electrostatic protection layer is electrically connected the at least one conductive structure; and
a display medium located between the pixel array substrate and the color filter substrate.

2. The display panel as claimed in claim 1, wherein the black matrix layer has a surface facing the pixel array substrate, and the electrostatic protection layer is at least located on a portion of the surface of the black matrix layer.

3. The display panel as claimed in claim 2, wherein the electrostatic protection layer covers the surface of the black matrix layer entirely and a side wall of the black matrix layer and fills into the first openings.

4. The display panel according to claim 2, wherein the electrostatic protection layer is not located in the first openings.

5. The display panel as claimed in claim 2, wherein the electrostatic protection layer comprises at lease one first electrode and at least one second electrode, and the at least one first electrode and the at least one second electrode are electrically insulated from each other.

6. The display panel as claimed in claim 5, wherein the at lease one first electrode and the at least one second electrode are patterns having a plurality of second openings, respectively, and the second openings exposes the first openings.

7. The display panel as claimed in claim 5, wherein the pixel array substrate comprises a plurality of transmission lines located in the non-display region, and wherein the at least one conductive structure comprises a plurality of conductive structures, the at least one first electrode is electrically connected to the corresponding transmission lines via the corresponding conductive structure, and the at least one second electrode is electrically connected to the corresponding transmission lines via the corresponding conductive structure.

8. The display panel as claimed in claim 7, wherein the at lease one first electrode and the at least one second electrode are touch electrodes, and when the transmission lines are electrically connected to a sensing voltage source, the display panel generates a capacitive touch signal as a response to a touch control operation.

9. The display panel as claimed claim 1, wherein the conductive structure comprises a plurality of conductive balls.

10. The display panel as claimed in claim 1, further comprising a pad located on the pixel array substrate and in the non-display region, wherein the electrostatic protection layer is electrically connected to the pad via the conductive structure, and the pad is electrically connected to a common voltage source.
